(19) United States
(12) Patent Application Publication
(10) Pub. No.: US 2019/0321954 A1
(43) Pub. Date: Oct. 24, 2019

(54) Garbage Disposal Snap Ring Installation Tool

(71) Applicant: Michael D. Bartlett, Santa Rosa, CA (US)

(72) Inventor: Michael D. Bartlett, Santa Rosa, CA (US)

(21) Appl. No.: 16/108,655

(22) Filed: Aug. 22, 2018

Related U.S. Application Data
(60) Provisional application No. 62/661,275, filed on Apr. 23, 2018.

(51) Int. Cl. B25B 27/30; B25B 27/00

(52) U.S. Cl. CPC B25B 27/30; E03C 1/266; B25B 27/0028

(57) ABSTRACT

A garbage disposal snap ring installation tool that allows installation of the snap ring from underneath the sink by holding the strainer flange in place from below and using a two part snap ring expansion tool to place the snap ring.

### CROSS-REFERENCES TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### 1. Field of the Invention

The present invention relates to garbage disposal installation tools. More specifically, the present invention relates to a tool for installing the snap ring which holds the garbage disposal mounting plate on the strainer flange.

### 2. Description of the Related Art

Plumbers and homeowners have long struggled with installation of garbage disposal units. One of the most difficult parts of installation is getting the snap ring onto the strainer flange while holding the mounting plate with its three bolts, the mounting plate cap, and the gasket, in place. The snap ring is necessarily difficult to spread over the end of the strainer flange without pushing the strainer flange up and out of the drain opening, and the entire assembly process must be done from under the sink. A single installer will have great difficulty without a second pair of hands working above the sink to hold the strainer flange in place. In addition, in this dark and small space, it is very difficult to see what you are doing, and to hold each element while installing the snap ring, particularly if the installer is a larger person who has difficulty fitting under the sink.

Several tools have been developed to resolve this issue, but all with significant drawbacks. For example, U.S. Pat. No. 5,584,110 issued to Mordoch Dec. 17, 1996, discloses a snap ring mounting tool that directly mounts to the lower opening of the strainer flange using detents. The tool includes a conical surface with a tapered diameter. The installer pushes the snap ring along the tapered surface, but the movement of the snap ring will tend to lift the strainer flange upward and there is no benefit unless there is a second person involved to retain the strainer flange in its proper position. The detents only serve to create a complexity in a tool that does not ultimately provide a benefit except to aid in spreading the snap ring during installation. In another example, U.S. Pat. No. 7,185,408 issued to Keith on Mar. 6, 2007, discloses an installation tool that securely holds all components together while installing the snap ring. The problem with this tool is that it is incredibly complex, requiring a biasing device, springs, and latching parts. The present invention resolves these issues by providing an elegant and inexpensive mechanism that allows a single installer to pre-assemble the components outside of the sink, install the assembly into place, and then, with a simple motion from below the sink, snap all components into place.

### BRIEF SUMMARY OF THE INVENTION

The present invention is a Garbage Disposal Snap Ring Installation Tool comprised of a shaft with a strainer flange retaining cap, a guide tool which expands the snap ring, and a sleeve that pushes the snap ring into place. The installer places the strainer flange in the sink and places the shaft with the strainer flange retaining cap into the strainer flange. The installer then assembles the gasket, the mounting plate cap, mounting plate with its three bolts, the snap ring and the sleeve, in that order, onto the guide tool. From under the sink, the installer slides the guide tool upward on the shaft, and holding the shaft firmly with one hand to keep the strainer flange in place, slides the sleeve upward over the guide tool with the other hand until all garbage disposal units are in place and the snap ring snaps into its groove on the strainer flange. The sleeve and guide tool are removed from under the sink and the shaft with retaining cap are pulled out of the top.

### BRIEF DESCRIPTION OF THE SEVERAL VIEWS OF THE DRAWINGS

A more complete understanding of the present invention may be derived by referring to the detailed description when considered in connection with the figures, wherein like reference numbers refer to similar items throughout the figures, and:

FIG. 1 is a side view of the Garbage Disposal Snap Ring Installation Tool assembly without any of the garbage disposal components;

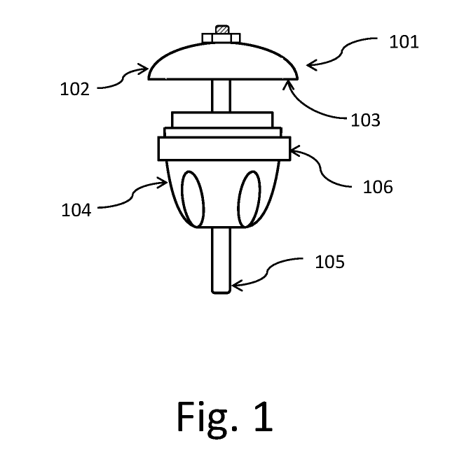

FIG. 2 is a side view of the garbage disposal components and the strainer flange with the Installation Tool Guide and Sleeve underneath;

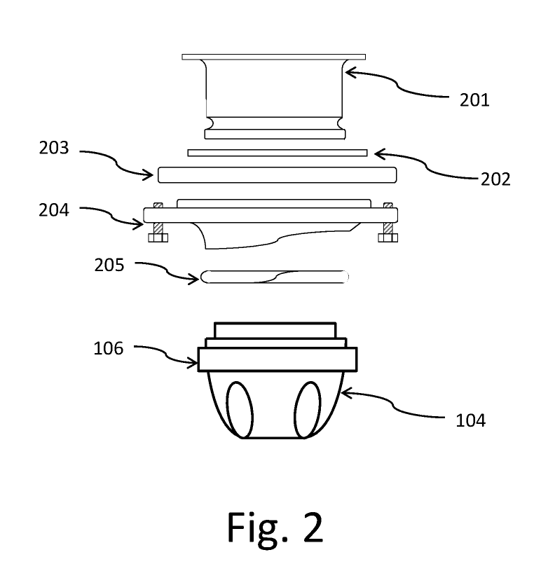

FIG. 3 shows a side view of the Tool when fully assembled with the garbage disposal and strainer flange components and with the snap ring shown in the before-installed and after-installed positions;

FIG. 4 shows a side view, top view and bottom view of the Guide Tool; and

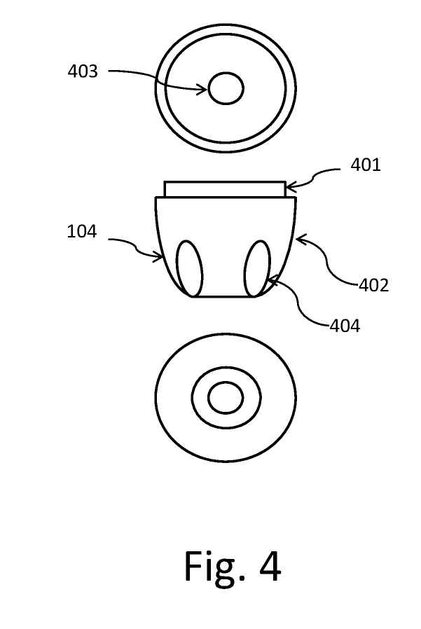

FIG. 5 shows a cross section of the Shaft and Retaining Cap Assembly and a side view and top view of the Sleeve.

### DETAILED DESCRIPTION OF THE INVENTION

In the following detailed description of the invention, reference is made to the accompanying drawings which form a part of the disclosure and which show by way of illustration, and not of limitation, specific embodiments by which the invention may be practiced. The drawings, the foregoing discussion, and the following description are exemplary and explanatory only, and are not intended to limit the scope of the invention or its application in any manner.

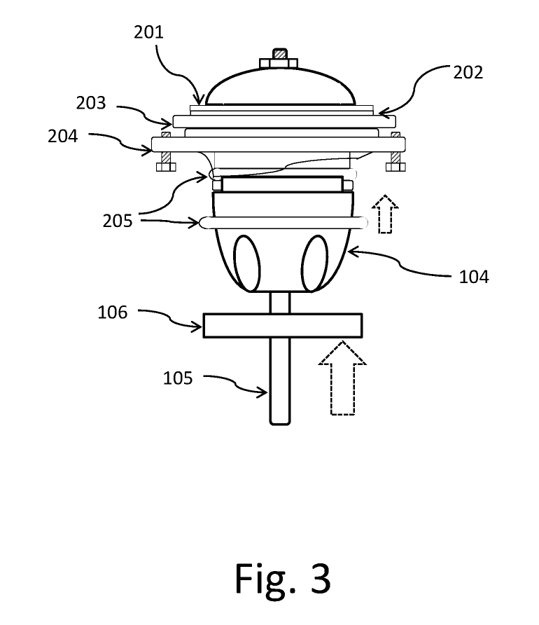

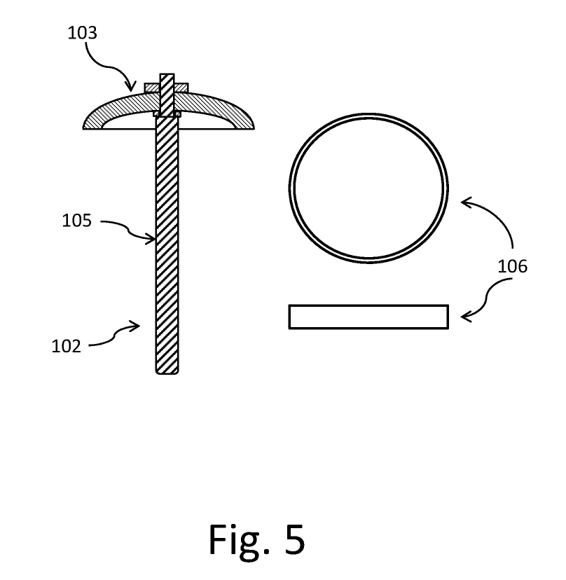

The present invention is a Garbage Disposal Snap Ring Installation Tool 101 comprised of a Shaft and Retaining Cap Assembly 102, a Guide Tool 104 and a Sleeve 106. The Shaft and Retaining Cap Assembly 102 includes a Retaining Cap 103 which is permanently fixed to a Shaft 105 that is long enough to extend through the garbage disposal components and the Guide Tool 104 as shown in FIG. 3, such that there is sufficient area below those components to comfortably grasp the bottom of the Shaft 105 to hold it in place. The shaft is preferably a strong metal rod, threaded at the top for easy connection to the Retaining Cap 103 with the use of standard nuts, although the two components may be connected using welding, glue or any other suitable means. The Retaining Cap 103 may be any shape, but is preferably a rounded cap with an interior arc to reduce weight as shown in FIG. 5. The outer diameter of the Retaining Cap 103 is the same as or slightly smaller than the top outer diameter of the Strainer Flange 201 and the surface area of the bottom of the Retaining Cap 103 is sufficient to hold the Strainer Flange 201 firmly in place when operating the Installation Tool 101.

The Guide Tool 104 is a generally round oblong component with a smaller Top Diameter Section 401, an Arced Body Section 402 and a Central Internal Hole 103. The Central Internal Hole 103 is slightly larger than the outer diameter of the Shaft 105 such that it easily glides over the Shaft 105. The Guide Tool 104 may be made from any suitable material, but a firm plastic or rubber is recommended to reduce weight, and for ease of manufacture. The Guide Tool 104 may also have optional Cutouts 404 to reduce weight and make it easier to grip the Guide Tool 104 during installation. The Top Round Section 401 is sized to fit inside the bottom of the Strainer Flange 201 such that the outer diameter of the tool is only slightly smaller than the inner diameter of the bottom section of the Strainer Flange and the height of the Top Round Section 401 is taller than the Gasket 202, the Mounting Plate Cap 203 and the Mounting Plate Assembly 204 when sandwiched together. The top of the Arced Body Section 102 is sized to match or be just slightly larger than the outer diameter of the bottom of the Strainer Flange 201 such that when the Guide Tool 104 is installed into the bottom of the Strainer Flange 201, the Snap Ring 205 can be pushed up the Arced Body Section 102 and snapped into place on the Strainer Flange 201 as shown in FIG. 3.

The Sleeve 106 is a round cylinder shape with an internal diameter just large enough to fit over the Arced Body Section 102 of the Guide Tool 104. The thickness of the Sleeve 106 is sufficient to provide structure such that when pushed against the Snap Ring 205 it can force the Snap Ring 205 up and over the Arced Body Section 102 of the Guide Tool 104 onto the Strainer Flange 201.

To operate the Installation Tool 101, the installer places the Strainer Flange 201 into the sink and places the Shaft and Retaining Cap Assembly 102 through the Strainer Flange 201 such that the Shaft 105 extends below the sink. The installer assembles the Mounting Plate Assembly 204, the Mounting Cap 203 and then the Gasket 202 onto the Top Round Section 401 of the Guide Tool 104. The installer then slides the Snap Ring 205 up the Arced Body Section 102 of the Guide Tool 104 until it is slightly expanded and holds position. The installer then slides the Sleeve 106 onto the Arced Body Section 102 of the Guide Tool 104 until it rests against the Snap Ring 205. Holding the entire assembly of Guide Tool 104, Sleeve 106 and components to be installed in one hand, the installer slides that assembly of components onto the bottom of the Shaft 105 under the sink. Using the other hand to grasp the Shaft 105 below the Guide Tool 104, while pulling down on the Shaft 105 to hold the Strainer Flange 201 in place, the installer pushes the Sleeve 106 upward, forcing the Snap Ring 205 into its groove in the bottom of the Strainer Flange 201. The Installation Tool 101 components are then removed and the installer may complete installation of the garbage disposal unit.

Many modifications and variations of this invention may be made without departing from its spirit and scope, as will be appreciated by those skilled in the art. The embodiment as described herein was chosen and described in order to best explain the principles of the invention and its practiced applications.

What is claimed is:

1. An installation tool for the snap ring of a garbage disposal comprising:
a retaining cap with an outer diameter that is the same as or slightly smaller than the top outer diameter of the strainer flange of the garbage disposal and a bottom surface that is flat;
a shaft with an outer diameter, a top end and an overall length, wherein the top end of the shaft is firmly fixed to the center of the bottom surface of the retaining cap and the overall length is approximately as long as the garbage disposal;
a guide tool with an oblong shape that has a top section, a bottom section and a longitudinal hole through the center with an inner diameter that is slightly larger than the outer diameter of the shaft, wherein the top section has an outer diameter that is slightly smaller than the inner diameter of the bottom section of the strainer flange of the garbage disposal and a height that is larger than the combined height of the gasket, the mounting plate cap, and the mounting plate assembly of the garbage disposal, and the bottom section has an outer diameter that is slightly larger than the outer diameter of the bottom section of the strainer flange of the garbage disposal; and
a sleeve with an inner diameter that is slightly larger than the outer diameter of the bottom section of the guide tool;
such that when the strainer flange is installed in a sink, the shaft can be inserted through the strainer flange from the top of the sink and the gasket, the mounting plate cap, the mounting plate assembly and the guide tool can be inserted onto the shaft, in that order, from under the sink and the snap ring of the garbage disposal can be slid onto the guide tool from under the sink and, while holding the strainer flange in place by pulling down on the shaft, the sleeve can be slid up the guide tool to push the snap ring into place on the strainer flange.
